(19) United States
(12) Patent Application Publication
(10) Pub. No.: US 2026/0042069 A1
(43) Pub. Date: Feb. 12, 2026

(54) EFFICIENT MILK FROTHING AND HEATING APPARATUS

(71) Applicant: GUANGDONG HUIJUN TECHNOLOGY GROUP LIMITED, Meizhou (CN)

(72) Inventor: Zhirong ZHOU, Meizhou (CN)

(73) Assignee: GUANGDONG HUIJUN TECHNOLOGY GROUP LIMITED, Meizhou, GD (CN)

(21) Appl. No.: 18/984,846

(22) Filed: Dec. 17, 2024

(30) Foreign Application Priority Data
Aug. 7, 2024 (CN) 202421909483.2

(51) Int. Cl. B01F 23/235; B01F 35/221; B01F 101/07

(52) U.S. Cl. CPC B01F 23/2351; B01F 35/2215; B01F 2101/07

(57) ABSTRACT

The present utility model relates to an efficient milk frothing and heating apparatus, including a lid body, a milk jar, a stirring assembly, and a heating assembly, where the lid body includes an upper lid and a lower lid that are fixedly connected, the stirring assembly includes a stirring rod and a stirring spring coil; a bottom of the heating assembly is provided with a heating ring. According to the present utility model, the milk frothing and heating apparatus has frothing and heating functions; the stirring spring coil performs stirring in a center of the milk jar, so that the milk can be frothed uniformly, thereby achieving high frothing efficiency; the heating ring performs heating in the center of the milk jar, so that all parts of the milk can be heated uniformly, thereby achieving high heat transfer efficiency.

### FIELD OF TECHNOLOGY

The present utility model relates to the technical field of electric appliances, specifically, to an efficient milk frothing and heating apparatus.

### BACKGROUND

With the improvement of people's living standards, coffee has gradually become the mainstream choice in daily beverages. Many consumers tend to add a layer of delicate milk froth on the surface of coffee when enjoying it. This not only gives the coffee a richer taste but also significantly improves the overall drinking experience of the coffee. Although a conventional electric milk frother uses an electric stirring function to produce milk froth, its structure is relatively complex, especially a milk jar has no built-in stirring head, which is very troublesome for cleaning the milk jar, thereby affecting the usage experience of a user to some extent.

In Chinese utility model No. CN202457888U, an electric milk frothing apparatus is disclosed, including a cup body and a lid body snapped on the cup body, where an electric motor is disposed inside the lid body and is connected to a stirring assembly by a transmission assembly, and when the lid body is connected to the cup body, the stirring assembly extends into the cup body from top to bottom. When cleaning is needed after use, the lid body is separated from the cup body, and the stirring assembly at the bottom of the lid body is pulled out from the cup body, and then the cup body can be conveniently cleaned.

However, due to the lack of the heating assembly, the above milk frothing apparatus has a single function and can only produce cold milk froth. So, people came up with an idea of providing a heating tube at the bottom of the lid body. When the lid body is snapped on the cup body, both the stirring assembly and the heating assembly can extend into the cup body from top to bottom. For example, a milk frother disclosed in Chinese utility model No. CN208973456U includes a milk cup and a main body covering the milk cup, where the main body is equivalent to a lid body of the milk cup; and a bottom of the main body is provided with a stirring apparatus and a heating rod that can both extend into the milk cup when the main body is connected to the milk cup. However, in this milk frother, only one side of the stirring rod is provided with the heating rod, resulting in low heat transfer efficiency; moreover, in order to provide the heating rod, the stirring apparatus is designed to deviate from the center in the cup, which also affects the milk frothing efficiency.

Therefore, there is an urgent need to design a milk frothing apparatus with the heating function and the high heat transfer efficiency and frothing efficiency, so as to fill the market gap.

### SUMMARY

To solve the problems of poor milk frothing efficiency and low heat transfer efficiency due to the fact that a stirring structure and a heating rod of an existing milk frother with a heating function cannot be centered in a milk jar, the present utility model provides an efficient milk frothing and heating apparatus.

A technical solution of the present utility model is as follows:

An efficient milk frothing and heating apparatus, including a lid body, a milk jar, a stirring assembly, and a heating assembly, where the lid body detachably covers the milk jar and includes an upper lid and a lower lid that are fixedly connected, and a working motherboard and a driving motor are disposed in a cavity between the upper lid and the lower lid; the stirring assembly includes a stirring rod, a top end of the stirring rod is connected to the driving motor and penetrates through a center of the lower lid, and a bottom end of the stirring rod is sleeved with a stirring spring coil; and the heating assembly is fixed to a bottom surface of the lower lid, a bottom of the heating assembly is provided with a heating portion that extends to a part under the center of the lower lid, and when the lid body covers the milk jar, the heating portion is soaked in milk in the milk jar, so that the heating assembly performs heating inside the milk.

By use of the above technical solution, when the lid body covers the milk jar, the stirring spring coil and the heating portion on the bottom surface of the lower lid both extend into the milk jar and are located in a middle of the milk jar; and after the stirring assembly and the heating assembly are started, the stirring spring coil stirs the milk in the middle of the milk jar, and the heating portion performs heating in a middle of the milk, so that the stirring efficiency and the heat transfer efficiency are both effectively improved.

According to the present utility model using the above solution, a middle of the lower lid is provided with a motor groove, a bottom of the motor groove protrudes downward to form a rod groove, a bottom of the rod groove is provided with a through hole, the driving motor is mounted in the motor groove and has an output shaft extending into the rod groove, and the top end of the stirring rod penetrates into the through hole in the bottom of the rod groove and is connected to the output shaft.

Further, a transmission shaft is disposed in the rod groove, and the stirring rod is connected to the output shaft by the transmission shaft.

Furthermore, the through hole is provided with a sealing ring.

According to the present utility model using the above solution, the bottom end of the stirring rod is bent into a circular fixing ring, and the stirring spring coil is sleeved on the fixing ring.

Preferably, the heating portion is a heating ring, and the stirring spring coil is located in a center of a ring opening of the heating ring.

According to the present utility model using the above solution, the heating assembly is connected to a bottom of the lid body by a connecting rod portion, and a lower part of the connecting rod portion is bent to form the heating ring.

Further, the connecting rod portion includes two parallel connecting rod bodies, one side of the lower lid is provided with two connecting holes, and the two rod bodies are correspondingly connected to the two connecting holes.

Further, the heating assembly includes a heating wire, insulating sleeve tubes, a temperature fuse, and a resistor, where the heating wire is disposed in the heating ring, the temperature fuse and the resistor are disposed in the insulating sleeve tubes, the insulating sleeve tubes are disposed in the connecting rod bodies, and the heating wire is electrically connected to the working motherboard by the temperature fuse and the resistor.

According to the present utility model using the above solution, a panel of the upper lid is provided with a plurality of functional buttons, and the functional buttons include a power button, a milk froth thickness selection button, a heating start button, and a chocolate making button.

According to the present utility model using the above solution, the milk jar is a milk frothing pitcher, and a spout of the milk frothing pitcher is provided with a flow guide groove.

The present utility model using the above solution has the following beneficial effects:
According to the present utility model, the driving motor is fixed inside the lid body and is centered, the stirring rod penetrates into the center of the lower lid and is closely connected to the driving motor to be directly driven by the motor, and the stirring spring coil is located in the center of the milk jar, so that the stirring efficiency is improved, thereby helping to improve the milk frothing efficiency; the heating assembly is disposed on one side of the lower lid, the heating portion at the bottom of the heating assembly extends to a part under the center of the lid body, and when the lid body covers the milk jar, the heating portion of the heating assembly is soaked in the milk to perform heating in the center of the milk, so that the present utility model has higher heat transfer efficiency than a conventional apparatus with a bottom heating or side heating structure;
the stirring assembly and the heating assembly in the present utility model are both disposed at the bottom of the lid body, so that when the lid body is mounted on the milk jar, the frothing and/or heating function can be implemented, thereby making it convenient to operate and use; and when the lid body is disassembled from the milk jar, the stirring assembly and the heating assembly can be separated from the milk jar at the same time, which is convenient for cleaning the milk jar.

### BRIEF DESCRIPTION OF THE DRAWINGS

FIG. 1 is a schematic structural diagram of the present utility model;

FIG. 2 is a schematic structural diagram of the present utility model after removal of a milk jar;

FIG. 3 is an exploded view of a partial structure of a lid body;

FIG. 4 is an exploded view of a structure of a stirring assembly; and

FIG. 5 is an exploded view of a structure of a heating assembly.

In the drawings:
1. lid body; 11. upper lid; 111. functional button; 12. lower lid; 121. motor groove; 122. rod groove; 123. through hole; 13. driving motor; 14. working motherboard; 15. transmission shaft;
2. stirring assembly; 21. stirring rod; 22. stirring spring coil;
3. heating assembly; 31. connecting rod body; 311. insulating sleeve tube; 312. temperature fuse; 32. heating ring; 321. heating wire;
4. milk jar; 41. spout; and 42. flow guide groove.

### DETAILED DESCRIPTION OF THE EMBODIMENTS

To better understand the objectives, technical solutions, and technical effects of the present utility model, the present utility model is further described below with reference to the accompanying drawings and embodiments. It should be noted that similar reference signs and letters represent similar items in the following accompanying drawings. Therefore, once an item is defined in an accompanying drawing, it is not required to be further defined and explained in the subsequent accompanying drawings. It is hereby declared that the embodiments described below are only used to explain the present utility model and are not intended to limit the present utility model.

It is to be noted that when one element is referred to as being “fixed to” or “disposed on” another element, it may be directly located on another element or there may also be a centered element. When one element is regarded to be “connected to” another element, it may be directly connected to another element or there may also be a centered element.

The indicated orientations or positional relationships are based on orientations or positional relationships shown in the accompanying drawings, customary orientations or positional relationships when the product in this application is in use, or orientations or positional relationships customarily understood by those skilled in the art, only for the convenience of describing the present application and simplifying the description rather than indicating or implying that the apparatus or element referred to must have a particular orientation or be constructed and operated in a particular orientation, and therefore cannot be construed as limitations to the present application.

The terms “first” and “second” are only for easy description, and cannot be construed as indicating or implying relative importance or implying the number of technical features. “a plurality of” means two or more, unless otherwise expressly and specifically defined.

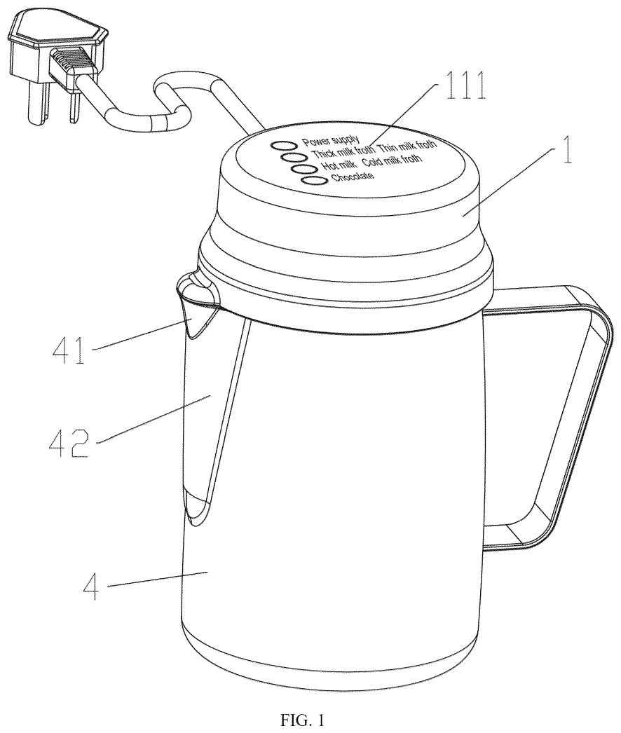

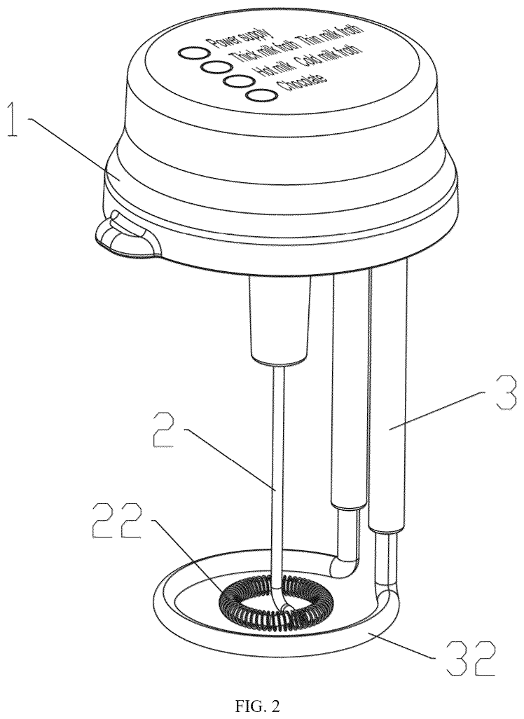

As shown in FIG. 1 and FIG. 2, an efficient milk frothing and heating apparatus has a milk frothing function and a heating function. During milk frothing, a stirring rod and a stirring spring coil perform stirring in a center of a milk jar, so that milk can be frothed uniformly, thereby achieving high frothing speed and efficiency; and a heating portion of a heating assembly performs heating in the center of the milk jar, so that all parts of the milk can be heated uniformly, thereby achieving high heat transfer efficiency. The efficient milk frothing and heating apparatus specifically includes a lid body and a milk jar. The lid body directly covers the milk jar for use. A stirring assembly and a heating assembly are both disposed at a bottom of the lid body. When the lid body is mounted on the milk jar, the frothing and/or heating function can be implemented, thereby making it convenient to operate and use; and when the lid body is disassembled from the milk jar, the stirring assembly and the heating assembly can be separated from the milk jar at the same time, which is convenient for cleaning the milk jar.

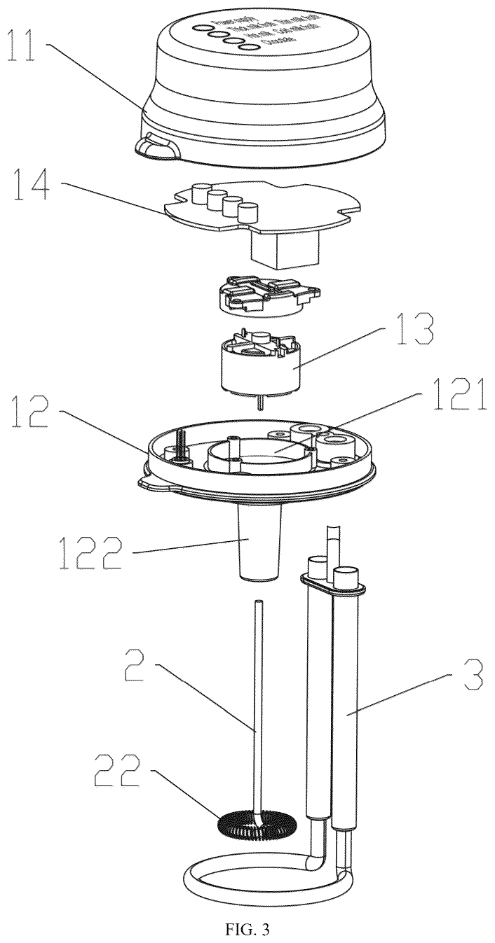

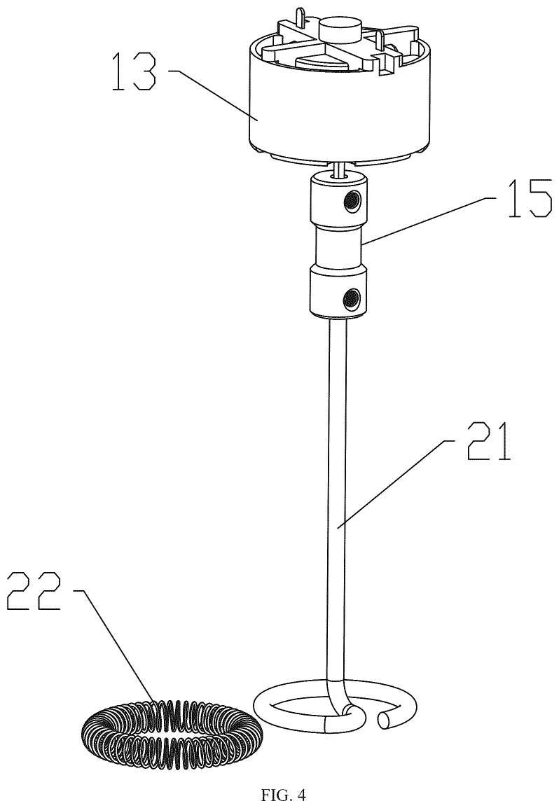

As shown in FIG. 3 and FIG. 4, in the present utility model, the lid body 1 includes an upper lid 11 and a lower lid 12. The upper lid 11 and the lower lid 12 are fixedly connected and cannot be disassembled, and a cavity is formed between them. A working motherboard 14 and a driving motor 13 of the apparatus are mounted in the cavity. One side of the upper lid 11 is connected to a power cord and a power plug. The upper lid 11 is designed in a circular truncated cone shape. An upper end part of the upper lid is relatively small for easy grip by a user. The diameter of a lower end part of the upper lid is slightly greater than the diameter of the milk jar 4, so that the upper lid can be well match with the milk jar 4. A panel of the upper lid 11 is provided with a plurality of functional buttons 111, and the functional buttons 111 include a power button, a milk froth thickness selection button, a heating start button, and a chocolate making button. The power button is configured to turn on or off the apparatus. After the apparatus is turned on, the milk froth thickness selection button is pressed once to switch between “thick milk froth” and “thin milk froth”; the heating start button is pressed once to switch between “hot milk” and “cold milk froth”; or when there is a need to make chocolate paste, the chocolate making button is pressed.

A middle of the lower lid 12 is provided with a motor groove 121, and the driving motor 13 is mounted in the motor groove 121, so that the driving motor 13 is placed in the center of the lid body 1, thereby facilitating the motor to directly drive a stirring rod 21. After the driving motor 13 is placed in the motor groove 121, a motor cover is tightened and fixed to a groove wall of the motor groove 121 by bolts, thereby ensuring that the driving motor 13 does not shake in the motor groove 121. A bottom of the motor groove 121 protrudes downward to form a rod groove 122, and an output shaft of the driving motor 13 extends into the rod groove 122. A bottom of the rod groove 122 is provided with a through hole 123, and a top end of the stirring rod 21 penetrates into the rod groove 122 from the through hole 123 and is connected to the output shaft of the driving motor 13. The output shaft is connected to the stirring rod 21 by a transmission shaft 15, and the transmission shaft 15 is exactly placed in the rod groove 122.

To protect the elements in the lid body 1 from contamination by the milk or other frothed liquids, a sealing ring is disposed at the through hole 123, and the stirring rod 21 penetrates through the sealing ring and then leaves the rod groove 122.

The stirring assembly 2 includes a stirring rod 21 and a stirring spring coil 22 sleeved at a bottom end of the stirring rod 21. It can be seen from the above structure that the top end of the stirring rod 21 is connected to the driving motor 13 and penetrates through a center of the lower lid 12. In addition, the bottom end of the stirring rod 21 is bent into a circular fixing ring, the stirring spring coil 22 is sleeved on the fixing ring, and an axis of the stirring rod 21 penetrates through a center of the stirring spring coil 22. When the stirring rod 21 rotates, the stirring spring coil 22 rotates about the axis of the stirring rod 21. The frothing efficiency is improved using the elasticity of a spring.

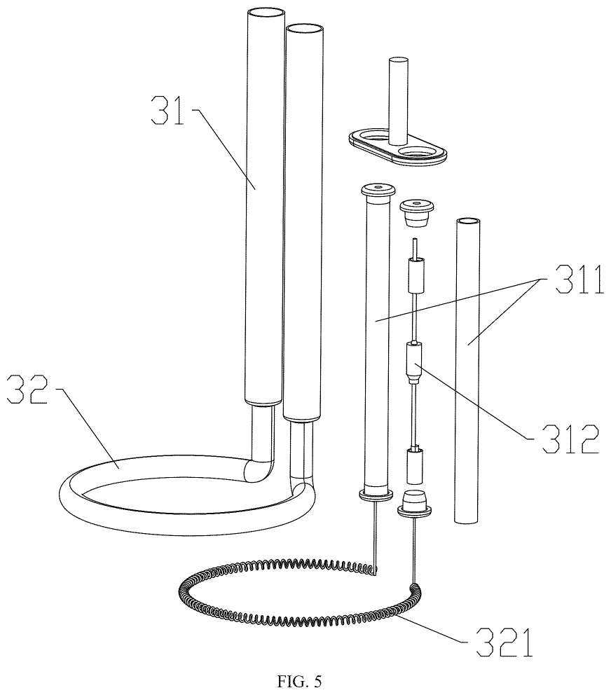

As shown in FIG. 5, the heating assembly 3 includes a stainless steel housing, a heating wire 321, insulating sleeve tubes, a temperature fuse 312, and a resistor. The stainless steel housing has two parallel connecting rod bodies 31, and bottoms of the two connecting rod bodies 31 are connected and bent to form a heating ring 32. The heating wire 321 is disposed in the heating ring 32. The insulating sleeve tube is disposed in each connecting rod body 31. The temperature fuse 312 and the resistor are disposed in the insulating sleeve tubes. Accordingly, the insulating sleeve tubes are configured to isolate the external stainless steel housing from the internal electronic elements.

In this embodiment, the heating portion adopts a ring structure or other polygonal structures such as a quadrilateral structure and a triangular structure.

The heating assembly 3 is fixedly connected to the lid body 1 by the connecting rod bodies 31. Specifically, one side of the lower lid 12 is provided with two connecting holes, and the two connecting rod bodies 31 are correspondingly connected to the two connecting holes respectively, so that the temperature fuse 312 and the resistor in the connecting rod bodies 31 penetrate into the lid body 1 to be electrically connected to the working motherboard 14, so that the heating wire 321 is electrically connected to the working motherboard 14 by the temperature fuse 312 and the resistor.

Although the connecting rod bodies 31 are disposed on one side of the lower lid 12, the heating ring 32 at the bottoms of the connecting rod bodies can be bent to be located below the center of the lower lid 12, so that the heating ring 32 and the stirring spring coil 22 are both located under the center of the lower lid 12.

In the present utility model, the milk jar 4 is a professional milk frothing pitcher. One side surface of the milk frothing pitcher is provided with a handle, and the other side surface thereof is provided with a spout 41. A flow guide groove 42 is formed between the spout 41 and a jar body to assist the user in latte art operation.

In summary, the milk frothing and heating apparatus in the present utility model has frothing and heating functions, and the driving motor is firmly fixed in the lid body. The apparatus has the advantage of low noise during operation, and the stirring rod in the center of the lower lid is controlled under direct drive of the motor, thereby achieving small transmission loss. The stirring spring coil performs stirring in the center of the milk jar, so that the milk can be frothed uniformly, thereby achieving high frothing efficiency; and the heating ring performs heating in the center of the milk jar, so that all parts of the milk can be heated uniformly, thereby achieving high heat transfer efficiency. When the lid body is disassembled from the milk jar, the stirring assembly and the heating assembly can be quickly disassembled at the same time, which is convenient for the user to clean the milk jar.

The technical features of the above embodiments may be combined arbitrarily. For the sake of brevity, all possible combinations of the technical features in the above embodiments are not described. However, the combinations of these technical features should be considered to be within the scope of this specification as long as there is no contradiction between them.

The above embodiments only express several implementations of the present utility model and are described more specifically and detailedly, but cannot be construed as limitations to the scope of patent of the present utility model. It should be pointed out that several modifications and improvements may also be made by those of ordinary skill in the art without departing from the conception of the present utility model, and all fall within the scope of protection of the present utility model. Therefore, the scope of patent protection of the present utility model shall be subject to the appended claims.

What is claimed is:

1. An efficient milk frothing and heating apparatus, comprising a lid body, a milk jar, a stirring assembly, and a heating assembly, wherein the lid body comprises an upper lid and a lower lid that are fixedly connected, and a working motherboard and a driving motor are disposed in a cavity of the lid body;
the stirring assembly comprises a stirring rod, a top end of the stirring rod is connected to the driving motor and penetrates through a center of the lower lid, and a bottom end of the stirring rod is sleeved with a stirring spring coil; and
the heating assembly is fixed to a bottom surface of the lower lid, a bottom of the heating assembly is provided with a heating portion that extends to a part under the center of the lower lid, and when the lid body covers the milk jar, the heating portion is soaked in milk in the milk jar, so that the heating assembly performs heating inside the milk.

2. The efficient milk frothing and heating apparatus according to claim 1, wherein a middle of the lower lid is provided with a motor groove, a bottom of the motor groove protrudes downward to form a rod groove, a bottom of the rod groove is provided with a through hole, the driving motor is mounted in the motor groove and has an output shaft extending into the rod groove, and the top end of the stirring rod penetrates into the through hole in the bottom of the rod groove and is connected to the output shaft.

3. The efficient milk frothing and heating apparatus according to claim 2, wherein a transmission shaft is disposed in the rod groove, and the stirring rod is connected to the output shaft by the transmission shaft.

4. The efficient milk frothing and heating apparatus according to claim 2, wherein the through hole is provided with a sealing ring.

5. The efficient milk frothing and heating apparatus according to claim 3, wherein the through hole is provided with a sealing ring.

6. The efficient milk frothing and heating apparatus according to claim 1, wherein the bottom end of the stirring rod is bent into a circular fixing ring, and the stirring spring coil is sleeved on the fixing ring.

7. The efficient milk frothing and heating apparatus according to claim 1, wherein the heating portion is a heating ring, and the stirring spring coil is located in a center of a ring opening of the heating ring.

8. The efficient milk frothing and heating apparatus according to claim 6, wherein the heating portion is a heating ring, and the stirring spring coil is located in a center of a ring opening of the heating ring.

9. The efficient milk frothing and heating apparatus according to claim 7, wherein the heating assembly is connected to a bottom of the lid body by a connecting rod portion, and a lower part of the connecting rod portion is bent to form the heating ring.

10. The efficient milk frothing and heating apparatus according to claim 9, wherein the heating assembly comprises a heating wire, insulating sleeve tubes, a temperature fuse, and a resistor, the heating wire is disposed in the heating ring, the temperature fuse and the resistor are disposed in the insulating sleeve tubes, the insulating sleeve tubes are disposed in connecting rod bodies, and the heating wire is electrically connected to the working motherboard by the temperature fuse and the resistor.

11. The efficient milk frothing and heating apparatus according to claim 8, wherein the heating assembly is connected to a bottom of the lid body by a connecting rod portion, and a lower part of the connecting rod portion is bent to form the heating ring.

12. The efficient milk frothing and heating apparatus according to claim 11, wherein the heating assembly comprises a heating wire, insulating sleeve tubes, a temperature fuse, and a resistor, the heating wire is disposed in the heating ring, the temperature fuse and the resistor are disposed in the insulating sleeve tubes, the insulating sleeve tubes are disposed in connecting rod bodies, and the heating wire is electrically connected to the working motherboard by the temperature fuse and the resistor.

13. The efficient milk frothing and heating apparatus according to claim 1, wherein a panel of the upper lid is provided with a plurality of functional buttons, and the functional buttons comprise a power button, a milk froth thickness selection button, a heating start button, and a chocolate making button.

14. The efficient milk frothing and heating apparatus according to claim 1, wherein the milk jar is a milk frothing pitcher, and a spout of the milk frothing pitcher is provided with a flow guide groove.
